(19) United States
(12) Patent Application Publication
(10) Pub. No.: US 2008/0310665 A1
(43) Pub. Date: Dec. 18, 2008

(54) Headphone and headset

(76) Inventors: Jan Peter Kuhtz, Celle (DE); Martin Streitenberger, Hannover (DE); Stefan Marten, Gailhof (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/154,976

(22) Filed: May 29, 2008

(30) Foreign Application Priority Data
May 31, 2007 (DE) 10 2007 025 589.8

(51) Int. Cl. H04R 1/10

(52) U.S. Cl. 381/375

(57) ABSTRACT

The invention is directed to a headphone or a headset with a microphone, at least one electroacoustic transducer, a signal processing unit), and a flexible printed circuit board. The flexible printed circuit board serves for electrically connecting the signal processing unit to the microphone and to the at least one electroacoustic transducer.

The present application claims priority from German Patent Application No. 10 2007 025 589.8, which was filed on May 31, 2007, the disclosure of which is incorporated herein by reference in its entirety.

### BACKGROUND OF THE INVENTION

1. Field of the Invention

The present invention is directed to a headphone and a headset.

2. Description of Related Art

When electronic devices such as, e.g., headphones, microphones and headsets are manufactured, it must be ensured that the microphones and transducers are connected to the associated electronics so as to be free of interference. In conventional microphones and/or headsets, a microphone capsule or electroacoustic transducer can be connected to the associated electronics by a cable by means of a solder joint. However, solder joints are prone to malfunction and the required cables may be too thick or too expensive to use in a microphone or headset.

The appropriate cable can be arranged on the outside for contacting the microphone capsule.

### SUMMARY OF THE INVENTION

It is the object of the present invention to provide a headphone or a headset which makes it possible to connect the electroacoustic transducers and/or microphones to an electronics unit so as to be free of interference.

Accordingly, a headphone is provided with a microphone, at least one electroacoustic transducer, a signal processing unit, and a flexible printed circuit board. The flexible printed circuit board serves to electrically connect the signal processing unit to a microphone and to the at least one electroacoustic transducer.

According to one aspect of the present invention, the signal processing unit is connected to a first terminal of the flexible printed circuit board by a plug connection.

The invention is further directed to a headset with a microphone, at least one electroacoustic transducer, a signal processing unit and a flexible printed circuit board. The flexible printed circuit board serves to electrically connect the signal processing unit to the microphone and to the at least one electroacoustic transducer.

The idea of the invention is to provide a connection for electronics units which is optimized in terms of manufacture, operates reliably, and has a reduced space requirement. To this end, a flex printed circuit board, or flexible printed circuit board, can be provided for contacting the respective units via solder contacts or plug contacts. The flex printed circuit board can also be used as a star-flex printed circuit board.

Further developments of the invention are indicated in the subclaims.

Embodiment examples and advantages of the invention are described more fully in the following with reference to the drawings.

### BRIEF DESCRIPTION OF THE DRAWINGS

FIG. 1 shows a schematic view of a contacting unit according to a first embodiment example;

FIG. 2 shows a schematic developed view of a contacting unit from FIG. 1; and

FIG. 3 shows a schematic view of headphones of a headset according to a second embodiment example.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The embodiment examples of the present invention relate to an electronic device such as headphones, a microphone or a headset in which contacting, for example, between the electroacoustic transducer and a signal processing unit is carried out by a flex printed circuit board or a star-flex printed circuit board.

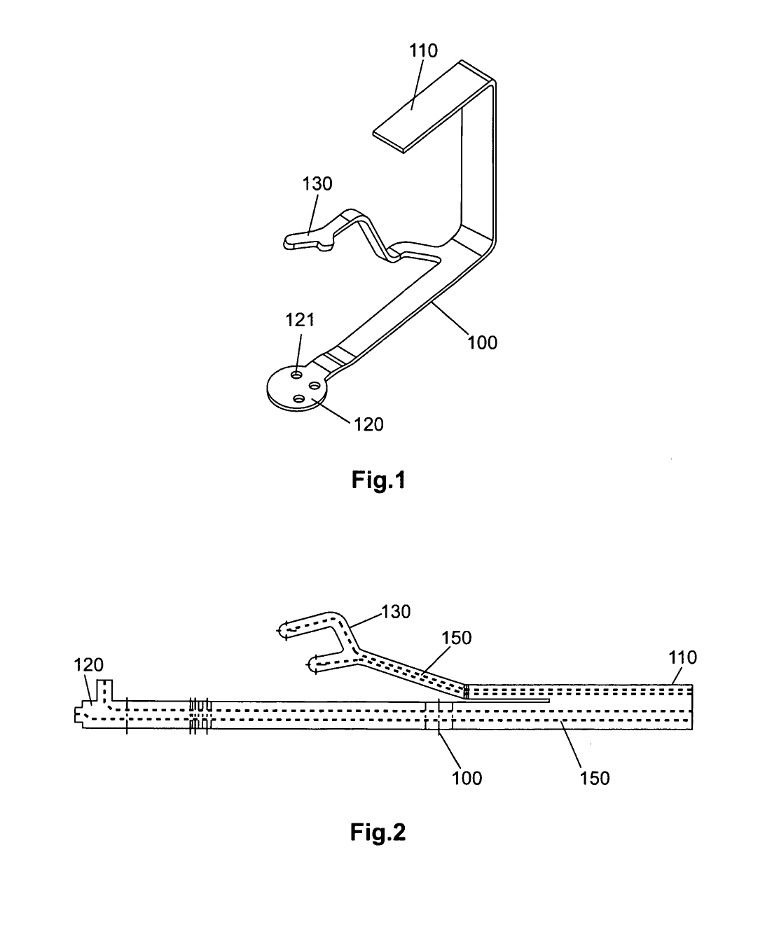

FIG. 1 shows a schematic view of a contacting unit according to a first embodiment example. The contacting unit 100 is designed as a flex printed circuit board or as a star-flex printed circuit board. The contacting unit has a first terminal 110, a second terminal 120, and a third terminal 130. Although only three terminals are shown in this first embodiment example, the contacting unit can have additional terminals.

The first terminal 110 serves as a connection for a signal processing unit which is arranged, for example, on a printed circuit board. This signal processing unit can serve, for example, to carry out active noise suppression ANR. The second terminal 120 can serve to contact a microphone capsule. The third terminal can serve to contact an electroacoustic transducer. The first terminal is connected to the second terminal and third terminal within the flex printed circuit board.

FIG. 2 shows a schematic view of a contacting unit from FIG. 1. The contacting unit 100 is likewise designed as a flex printed circuit board or as a star-flex printed circuit board and has a first terminal 110 for connecting to a signal processing unit, a second terminal 120 for connecting a microphone capsule, and a third terminal 130 for connecting an electroacoustic transducer. Electric leads 150 run within the flex printed circuit board from the second terminal 120 and third terminal 130 to the first terminal 110.

Accordingly, an electrically shielded, thin or flat contacting unit can be provided which makes possible a flexible connection of electric components. In doing so, contact can be made by means of defined solder joints or by plug contacts. A microphone and an electroacoustic transducer—in headphones or a headset or a microphone—can be connected to the electronic signal processing unit arranged downstream by means of the contacting unit described above.

The design of the flex printed circuit board reduces the space requirement because a cable tree having round cables can now be dispensed with. Further, the design of the contacting unit as a flex printed circuit board permits a flat construction for mounting in front of or in the resonator. In addition or alternatively, a flat construction can be carried out between a transducer diaphragm and the resonator.

Further, assembly can be simplified in that the solder joints or plug contacts, as the case may be, can be handled more easily. Further, fewer cables are required in assembly. A transducer-resonator unit can be flexibly connected to the printed circuit board of the signal processing unit by means of the flex printed circuit board. Moreover, an additional functionality can be implemented on the flex printed circuit board.

The holes 121 in the second terminal 120 can be constructed in such a way that a sponge effect or capillary action occurs when solder is applied to the second terminal 120.

The first terminal 110 can be designed, for example, as a plug contact with contact monitoring.

The flex printed circuit boards or flexible printed circuit boards are based, e.g., on a polyimide foil. Flex circuits such as this are very economical with respect to space and can be used in very confined structures by folding.

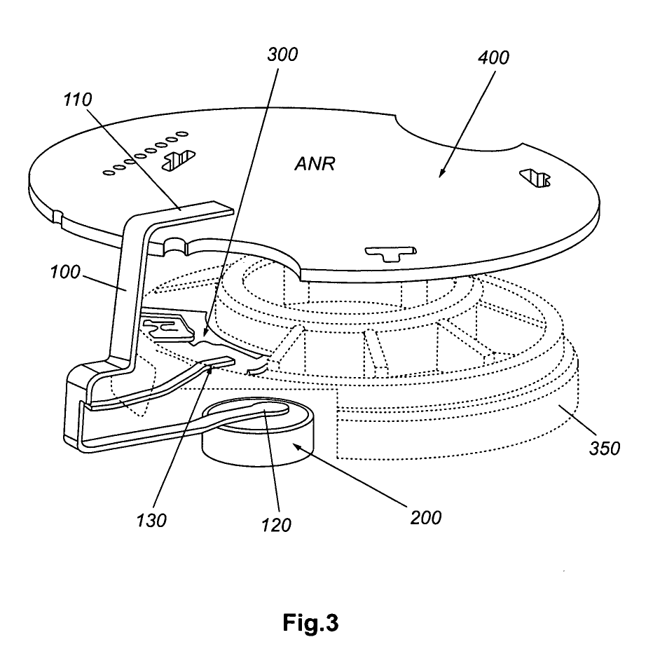

FIG. 3 shows a schematic view of a part of a headphone or a headset according to a second embodiment example. FIG. 3 shows not only the contacting unit 100, but also the microphone capsule 200, the transducer printed circuit board 300, transducer 350, and earpiece printed circuit board 400. The earpiece printed circuit board 400 with the signal processing unit ANR located thereon is connected to the contacting unit by the first terminal 110. The second terminal 120 is connected to the microphone capsule 200. The third terminal 130 of the contacting unit 100 is coupled or connected to the transducer printed circuit board 300 and, therefore, to the electroacoustic transducer 350.

The contacting unit shown in FIG. 3 can be constructed as a contacting unit according to FIG. 1 or FIG. 2.

The contacting unit described above can also be used in a microphone, a headset or other electrical and/or electronic devices.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

What is claimed is:

1. A headphone comprising:
a microphone;
at least one electroacoustic transducer;
a signal processing unit; and
a flexible printed circuit board which electrically connects the signal processing unit to the microphone and to the at least one electroacoustic transducer.

2. The headphone according to claim 1;
wherein the signal processing unit is arranged on an earpiece printed circuit board, and is connected to the first terminal of the printed circuit board by a plug connection.

3. The headphone according to claim 1;
wherein the microphone is connected to a second terminal of the printed circuit board.

4. The headphone according to claim 1;
wherein the at least one electroacoustic transducer is connected to a third terminal of the printed circuit board.

5. A headset comprising:
a microphone;
at least one electroacoustic transducer;
a signal processing unit; and
a flexible printed circuit board which electrically connects the signal processing unit to the microphone and to the at least one electroacoustic transducer.

6. The headset according to claim 5;
wherein the signal processing unit is arranged on an earpiece printed circuit board, and is connected to the first terminal of the printed circuit board by a plug connection.

7. The headset according to claim 5;
wherein the microphone is connected to a second terminal of the printed circuit board.

8. The headset according to claim 5;
wherein the at least one electroacoustic transducer is connected to a third terminal of the printed circuit board.
